(19) United States
(12) Patent Application Publication
(10) Pub. No.: US 2004/0143618 A1
(43) Pub. Date: Jul. 22, 2004

(54) Method for multiplying two binary numbers

(76) Inventors: David Naccache, Paris (FR); Christophe Tymen, Versaille (FR)

Correspondence Address: BURNS DOANE SWECKER & MATHIS L L P, POST OFFICE BOX 1404, ALEXANDRIA, VA, 22313-1404, US

(21) Appl. No.: 10/467,718

(22) PCT Filed: Feb. 8, 2002
(86) PCT No.: PCT/FR02/00495

(30) Foreign Application Priority Data
Feb. 12, 2001 (FR) 01/01835

(51) Int. Cl. G06F 7/52

(52) U.S. Cl. 708/622

(57) ABSTRACT

A cryptography process utilizes the product of two numbers to generate a key. At least one of the numbers is the result of concatenating a first constant whose bits are all equal to one, and a first variable of u bits. The other number has a length of s bits. The product of the two numbers is obtained from a series of operations, in which the most complex operation involves a multiplication of u bits by s bits.

The present invention relates to a method for multiplying two binary numbers.

Multiplication is an arithmetic operation performed by digital processors by means of elementary operations such as shifting or addition. The complexity of a multiplication can be assessed by estimating the quantity of elementary operations to be performed in order to arrive at the result. It depends directly on the size of the two numbers to be multiplied.

Thus, when large numbers are involved, this complexity affects both the calculation power required and the time necessary for obtaining the result.

The object of the present invention is thus a multiplication method having reduced complexity.

According to the invention, a method is provided for calculating the product of first and second binary numbers, the first number resulting from the concatenation of a first constant A and a first variable X of u bits, all the bits of the first constant A being equal to 1, the second number comprising s bits, a method according to which this product results from a series of operations, the most complex of which is a multiplication of u bits by s bits.

By reducing the size of the numbers to be multiplied, even though it is necessary to perform additional operations, the number of elementary operations to be performed in order to obtain the product is substantially reduced.

According to a first option, the first constant A comprising 1 bits, the method comprises the following operations:

a first operation of left shifting the second number by (u+1) bits in order to obtain a first operand,

a second operation of left shifting by u bits and sign reversal of the second number in order to obtain a second operand,

a third operation of multiplying the first variable X by the second number in order to obtain a third operand,

the product resulting from the sum of the first, second and third operands.

Advantageously, when the second number results from the concatenation of a second constant B whose m bits are equal to 1 and a second variable Y of v bits, the third operand is obtained by means of the following operations:

a fourth operation of left shifting the first variable X by (v+m) bits in order to obtain a fourth operand,

a fifth operation of left shifting by v bits and sign reversal of the first variable X in order to obtain a fifth operand,

a sixth operation of multiplication of the first X and second Y variables in order to obtain a sixth operand,

the third operand resulting from the sum of the fourth, fifth and sixth operands.

According to a second option, the first constant A comprising 1 bits, the second number resulting from the concatenation of the first constant A and a second variable Y of u bits, the method comprises the following operations:

a first operation of adding the first variable X and the second number in order to obtain a first operand,

a second operation of left shifting the first operand by (u+1) bits in order to obtain a second operand,

a third operation of left shifting by u bits and sign reversal of the first operand in order to obtain a third operand,

a fourth operation of multiplying the first variable X by the second variable Y in order to obtain a fourth operand,

the product resulting from the sum of the second, third and fourth operands.

According to a third option, the first constant A comprising 1 bits, the second number resulting from the concatenation of a second constant B whose m bits are equal to 1 and a second variable Y of v bits, the method comprises the following operations:

a first operation of defining a first operand whose value is 2exp(u+v+1+m)−2exp(u+v+1)−2exp(u+v+m)+2exp(u+v),

a second operation for calculating a second operand equal to (A.Y+B.X),

a third operation of multiplying the first variable X by the second variable Y in order to obtain a third operand,

the product resulting from the sum of the first, second and third operands.

The second operand preferably results from the following operations:

a fourth operation of left shifting the second variable Y by (u+1) bits in order to obtain a fourth operand,

a fifth operation of left shifting by u bits and sign reversal of the second variable Y in order to obtain a fifth operand,

a sixth operation of left shifting the first variable X by (v+m) bits in order to obtain a sixth operand,

a seventh operation of left shifting by v bits and sign reversal of the first variable X in order to obtain a seventh operand,

the second operand resulting from the sum of the fourth, fifth, sixth and seventh operands.

Alternatively, the second constant B being equal to the first constant A, the number v of bits of the second variable Y being equal to the number u of bits of the first variable X, the second operand results from the following operations:

a fourth operation of addition of the first X and second Y variables in order to obtain a fourth operand,

a fifth operation of left shifting the fourth operand by (u+1) bits in order to obtain a fifth operand,

a sixth operation of left shifting by u bits and sign reversal of the fourth operand in order to obtain a sixth operand,

the second operand resulting from the sum of the fifth and sixth operands.

According to a fourth option, the first and second numbers being equal, the method comprises the following operations:

a first operation of defining a first operand whose value is 2exp(2(u+1))−2exp(2u+1+1)+2exp(2u),

a second operation of left shifting the first variable X by (u+1+1) bits in order to obtain a second operand,

a third operation of left shifting by (u+1) bits and sign reversal of the first variable X in order to obtain a third operand,

a fourth operation of squaring the first variable X in order to obtain a fourth operand,

the product resulting from the sum of the first, second, third and fourth operands.

The invention also relates to a device comprising means for implementing the above method.

It advantageously applies to cryptography, in particular to the enciphering of a signature.

The present invention will now emerge with more details in the context of the following description of example embodiments given by way of illustration with reference to the accompanying figures, which show:

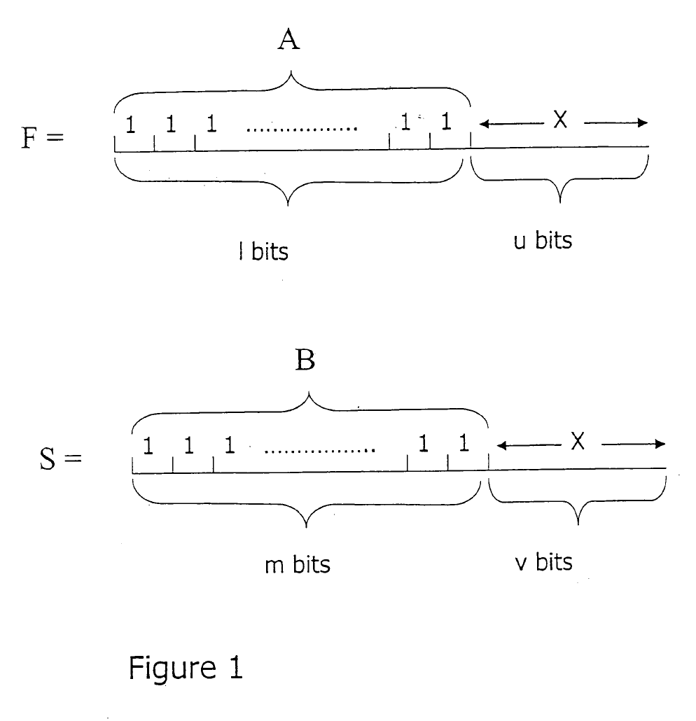

FIG. 1, a representation of two binary numbers, and

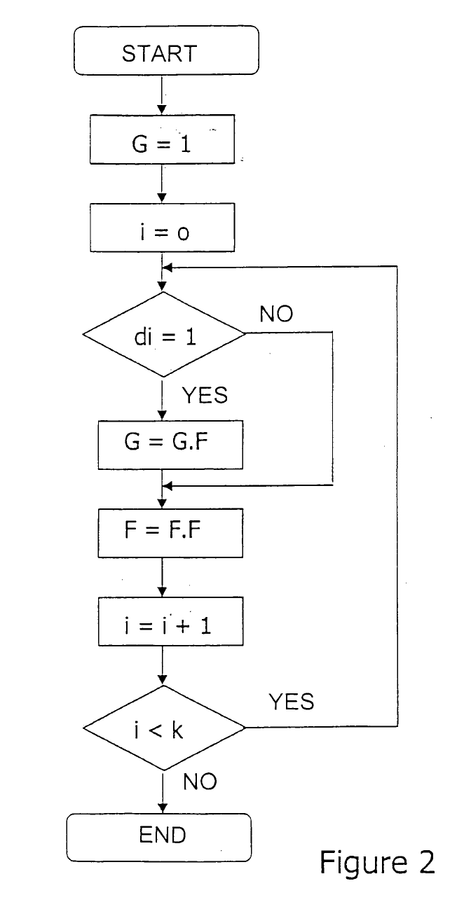

FIG. 2, a flow diagram of the enciphering method.

It is necessary firstly to state that all the operations described are performed modulo n where n has a predetermined value. This is not a real limitation since every latitude is permitted in the choice of this value. Moreover, in practice, the registers of the processors have a limited size, so that the majority of the operations are performed modulo this size.

With reference to FIG. 1, the first number F can be analysed as the concatenation of a first constant A and a first variable X. The constant A comprises 1 bits all equal to 1 and the variable X has a length of u bits. The invention has an advantage when the value of 1 is greater than 1, although it also applies in the contrary case.

By denoting a raised to the power of b as A expb, the constant A is equal to:

A=2expl−1

The first number F is expressed thus:

F=A.2expu+X

F=2expu.(2expl−1)+X

The product P of the first number F and of the second number S of s bits becomes:

P=F.S

P=(2expu.(2expl−1)+X)S

P=2exp(u+1).S−2expu.S+X.S [1]

The product P is therefore analysed as the sum of three operands. The first operand, which is equal to 2exp(u+1).S, is obtained by effecting a left shift on the second number S by (u+1) bits and, naturally, by forcing to 0 the (u+1) least significant bits of the shifted number.

The second operand, which is equal to 2expu.S, is obtained by effecting a left shift by u bits and a sign reversal.

The third operand is obtained by multiplying the first variable X by the second number S, by means of any known method.

The invention thus makes it possible to substitute for a multiplication of (u+1) bits by s bits a set of operations comprising two shifts, a sign reversal, two additions and a multiplication of u bits by s bits.

The advantage procured by the invention is all the more substantial when 1 is large.

The second number S can also be analysed as the concatenation of a constant B and a variable Y. The constant B comprises m bits equal to 1 and the variable Y has a length of v bits, the second number then being written:

S=2expv.(2expm−1)+Y

The third operand of equation [1] becomes:

X.S=(2expv.(2expm−1)+Y).X

X.S=2exp(v+m).X−2expv.X+X.Y

The third operand X.S is also analysed as the sum of three operands, the fourth operand, which is equal to 2exp(v+m).X, which is obtained by effecting a left shift on the first variable X by (v+m) bits, the fifth operand, which is equal to −2expv.X, which is obtained by effecting a left shift by v bits and a sign reversal and the sixth operand which is obtained by multiplying the first X and second Y variables.

In this case, the most complex operation is a multiplication of u bits by v bits.

According to a first variant, the operation takes advantage of the fact that the second constant B is equal to the first constant A and the size v of the second variable Y is identical to the size u of the first variable X.

The product P is then written:

P=(A.2expu+X).S

P=A.2expu.S+S.X

P=A.2expu.S+(A.2expu+Y).S

P=A.2expu.S+A.2expu.X+X.Y

P=A.2expu.(S+X)+X.Y

P=2exp(u+1).(S+X)−2expu.(S+X)+X.Y [2]

The product P is here obtained by means of the following four operations.

A first operand is obtained by adding the first variable X and the second number S. A second operand is obtained by left shifting the first operand by (u+l) bits. A third operand is obtained by left shifting by u bits and sign reversal of the first operand. A fourth operand is obtained by multiplying the first X and second Y variables. Finally, the product F is obtained by adding these four operands.

According to another variant, the invention also considers that the first F and respectively the second number S result from the concatenation of a first constant A and a first variable X, or respectively of a second constant B and a second variable Y.

Taking the same notations, the product P is then written:

P=(A.2expu+X).(B.2expv+Y)

P=A.B.2exp(u+v)+A.2expu.Y+B.2expv.X+X.Y

The product P is also presented here as the sum of three operands.

The first operand, which is equal to A.B.2exp(u+v), is easily defined as any binary number expressed by a series of coefficients each corresponding to a power of 2.

The second operand is equal to (A.2expu.Y+B.2expv.X) and the third operand is obtained by multiplying the first X and second Y variables.

According to a first option the second operand is calculated directly from the expression 2exp(u+1).Y=2expu.Y+2exp(v+m).X−2expv.X.

It is thus necessary to proceed with a left shift of the second variable Y by (u+1) bits, a left shift by u bits and a sign reversal of this variable Y, a left shift of the first variable X by (v+m) bits, a left shift by v bits and a sign reversal of this variable X and, finally, adding the results of the above four operations.

According to a second option, when the two constants A and B are equal and the sizes u and v of the two variables are identical, the second operand is then written: 2exp(u+1).(X+Y)−2expu.(X+Y).

The first step here is to add the two variables X and Y, a left shift by (u+1) bits is applied to this sum, a left shift by u bits and a sign reversal are applied to this sum and finally the results of the previous two operations are added.

According to yet another variant of the invention, the two numbers F and S are equal, which amounts to stating that the multiplication becomes a squaring of the first number F.

F=A.2expu+X

F=2exp(u+1)−2expu+X

P=(2exp(u+1)−2expu+X) exp2

P=[2exp(2(u+1)−2exp(2u+1+1)+2exp2u)]+2exp(u+1+1).X−2exp(u+1).X+Xexp2 [3]

The product P appears here also as the sum of four operands.

The first operand which appears between square brackets in equation [3] above is a simple binary number.

The second operand is obtained by a left shift of the variable X by (u+1+1) bits. The third operand is obtained by a left shift of this variable X by (u+1) bits. The fourth operand is therefore obtained by squaring the variable X.

The invention presented above thus makes it possible to reduce the size of the numbers which must be multiplied when calculating a product.

It can be used on any numbers, in which case it is necessary first of all to identify the first constant A by seeking a series of bits at 1 at the head of the first number. It can also be employed when this constant A is known a priori.

It will preferentially be used in the fields dealing with large numbers. This is the case with cryptography.

By way of example, reference is made to the standard PKCS#1 which defines in particular the signature G of a message m in the context of the enciphering algorithm known as RSA (from the name of its authors Ron Rivest, Adi Shamir and Leonard Adleman). By denoting | the concatenation operation and mod the modulo operator:

F=A|P|h(m)

G=Fexpdmodn

This is an operation known as modular exponentiation. The term A is a constant where all the bits, often several hundreds, are equal to 1. The term P is a parameter with a size of approximately 10 bytes. The term h(m) represents a hash function of the message m, with a fixed length, typically 20 bytes.

It is clear that the number F is the concatenation of a constant A and a variable X of value P|h(m) comprising k bits.

The term d is an exponent. The term n is the modulus according to which the signature G is calculated and is equal to the product of two large prime numbers. The terms d and n define what is agreed to be called the public key used for enciphering.

With reference to FIG. 2, a method of calculating the signature G is now described whilst considering that the bit dᵢ is the i^{th} bit of the exponent d, i therefore varying from 0 to (k−1). This method is known by the term “Square and Multiply”.

During a first step, the signature G and the index i are respectively initialised to 1 and 0. Following a first test, if the bit dᵢ is equal to 1, a step of multiplying the signature G by the number F is performed. The signature G now taking the value of the result of this operation. Next, whatever the value of this bit dᵢ, a step of squaring the number F is performed, this number F now taking the value of the result of this last operation.

The index i is then incremented by one unit and a second test is performed on the value of this index. If this is equal to k, the method is terminated, whilst in the contrary case the method is continued by resuming the first test.

It is thus clear that the multiplication method described above can advantageously be applied to the multiplication step and to the squaring step of the above method.

The invention also relates to a device for implementing the multiplication method. This device, a processor comprising known elements such as an accumulator, a shift register, an adder and a multiplier, will consequently not be detailed further.

The example embodiments of the invention presented above have been chosen for their concrete character. It would however not be possible to exhaustively list all the embodiments covered by this invention. In particular, any step or means described can be replaced by an equivalent step or means without departing from the scope of the present invention.

1. A cryptographic process using a method for calculating the product of first (F) and second (S) binary numbers in an electronic component comprising a processor, the said first number (F) resulting from the concatenation of a first constant A and a first variable X of u bits, all the bits of the said first constant A being equal to 1, the said second number comprising s bits,
a process characterised in that the said product results from a series of operations, the most complex of which is a multiplication of u bits by s bits.

2. A cryptographic process according to claim 1, characterised in that, the said first constant A comprising 1 bits, the mathematical method comprises the following operations:
a first operation of left shifting the said second number (S) by (u+1) bits in order to obtain a first operand,
a second operation of left shifting by u bits and sign reversal of the said second number (S) in order to obtain a second operand,
a third operation of multiplying the said first variable X by the said second number (S) in order to obtain a third operand,
the said product resulting from the sum of the said first, second and third operands.

3. A cryptographic process according to claim 2, characterised in that, the said second number (S) resulting from the concatenation of a second constant B whose m bits are equal to 1 and a second variable Y of v bits, the said third operand is obtained by means of the following operations:
a fourth operation of left shifting the said first variable X by (v+m) bits in order to obtain a fourth operand,
a fifth operation of left shifting by v bits and sign reversal of the said first variable X in order to obtain a fifth operand,
a sixth operation of multiplication of the said first X and second Y variables in order to obtain a sixth operand,
the said third operand resulting from the sum of the said fourth, fifth and sixth operands.

4. A cryptographic process according to claim 1, characterised in that, the said first constant A comprising 1 bits, the said second number (S) resulting from the concatenation of the said first constant A and a second variable Y of u bits, it comprises the following operations:
a first operation of adding the said first variable X and the said second number (S) in order to obtain a first operand,
a second operation of left shifting of the said first operand by (u+1) bits in order to obtain a second operand,
a third operation of left shifting by u bits and sign reversal of the said first operand in order to obtain a third operand,
a fourth operation of multiplying the said first variable X by the said second variable Y in order to obtain a fourth operand,
the product resulting from the sum of the said second, third and fourth operands.

5. A cryptographic process according to claim 1, characterised in that, the said first constant A comprising 1 bits, the said second number (S) resulting from the concatenation of a second constant B whose m bits are equal to 1 and a second variable Y of v bits, it comprises the following operations:
a first operation of defining a first operand whose value is 2exe(u+v+1+m)−2ex(u+v+1)−2exp(u+v+m)+2exp(u+v),
a second operation for calculating a second operand equal to (A.Y+B.X),
a third operation of multiplying the said first variable X by the said second variable Y in order to obtain a third operand,
the said product resulting from the sum of the said first, second and third operands.

6. A cryptographic process according to claim 5, characterised in that the said second operand results from the following operations:
a fourth operation of left shifting the said second variable Y by (u+1) bits in order to obtain a fourth operand,
a fifth operation of left shifting by u bits and sign reversal of the second variable Y in order to obtain a fifth operand,
a sixth operation of left shifting the said first variable X by (v+m) bits in order to obtain a sixth operand,
a seventh operation of left shifting by v bits and sign reversal of the first variable X in order to obtain a seventh operand,
the said second operand resulting from the sum of the said fourth, fifth, sixth and seventh operands.

7. A cryptographic process according to claim 5, characterised in that, the said second constant B being equal to the said first constant A, the number v of bits of the second variable Y being equal to the number u of bits of the first variable X, the said second operand results from the following operations:
a fourth operation of addition of the first X and second Y variables in order to obtain a fourth operand,
a fifth operation of left shifting the said fourth operand by (u+1) bits in order to obtain a fifth operand,
a sixth operation of left shifting by u bits and sign reversal of the said fourth operand in order to obtain a sixth operand,
the said second operand resulting from the sum of the said fifth and sixth operands.

8. A cryptographic process according to claim 1, characterised in that, the said first (F) and second (S) numbers being equal, the mathematical method comprises the following operations:
a first operation of defining a first operand whose value is tex(2(u+1))−2 eex(2u+1+1)+2exp(2u),
a second operation of left shifting the said first variable X by (u+1+1) bits in order to obtain a second operand,
a third operation of left shifting by (u+1) bits and sign reversal of the said first variable X in order to obtain a third operand,
a fourth operation of squaring the said first variable X in order to obtain a fourth operand,
the product resulting from the sum of the said first, second, third and fourth operands.

9. A cryptographic process according to any one of claims 1 to 8 applied to the enciphering of a signature.
